(19) United States
(12) Patent Application Publication
(10) Pub. No.: US 2018/0158088 A1
(43) Pub. Date: Jun. 7, 2018

(54) GRAPHICAL USER INTERFACE DISPLAYING POST-INTERACTION ANIMATIONS

(71) Applicant: GOOGLE LLC, Mountain View, CA (US)

(72) Inventors: Denise Ho, Los Altos, CA (US); Daniel Talavera, San Francisco, CA (US)

(21) Appl. No.: 15/829,373

(22) Filed: Dec. 1, 2017

Related U.S. Application Data
(60) Provisional application No. 62/429,608, filed on Dec. 2, 2016.

(51) Int. Cl. G06Q 30/02; G06Q 20/36; G06Q 20/34; G07F 17/32

(52) U.S. Cl. CPC G06Q 30/0209; G06Q 20/36; G06Q 20/352; H04W 4/008; G07F 17/3255; G07F 17/323; G07F 17/3295

(57) ABSTRACT

Rendering graphical user interfaces to display post-interaction experiences to users comprises an application of a user. The application provides a display to a user to initiate a wireless interaction and receives a notification of a tap of the one or more computing devices to conduct a pending interaction at a third party system. The application receives a notification from a third party system that the interaction has been conducted and communicates to a computing system associated with the application that the interaction has been conducted. The application receives from the computing system a post-interaction experience. The graphical user interface renders the post-interaction experience for display to the user and displays a received reward to the user.

### CROSS-REFERENCE TO RELATED APPLICATION

This patent application claims priority to U.S. Patent Application No. 62/429,608, filed Dec. 2, 2016, and entitled “Post-Transaction Incentives for Digital Wallet Transactions.” The entire contents of the above-identified application are hereby fully incorporated herein by reference.

### TECHNICAL FIELD

The present disclosure relates to a graphical user interface for displaying a post-interaction animation on a user computing device. More specifically, a graphical user interface to provide an animation to a user after a desired interaction type to incentivize and encourage additional interactions of that type.

### BACKGROUND

User computing devices communicate with the other computing devices via near field communication (“NFC”), BLUETOOTH, barcodes, Wi-Fi, infrared, or any other suitable communication technology. The user computing device can host a applications that can be used to communicate with the other computing devices.

Providers of applications and other parties may desire to drive a greater number of interactions towards using a new communication technology. Because users have other options to initiate and conduct interactions, these entities need a manner of encouraging and incentivizing further interactions, such as NFC interactions. However, NFC interactions may be intimidating to new users, despite the fact that NFC interactions may be quicker, more efficient, and just as secure as other types of interactions. Thus, when users do not elect to use an incentivized technology, all of the related computing devices are forced to perform additional processing and expend additional capacity.

### SUMMARY

Techniques herein provide computer-implemented methods, systems, and computer program products to render graphical user interfaces to display post-interaction experiences to users, in particular post-interaction game experiences. The method comprises a computing system employing a server configured to manage an account and an application for a user. An application is displayed to a user to initiate a wireless interaction and receives a notification of a tap of the one or more computing devices to conduct a pending interaction at a third party system. The application receives a notification from the third party system that the interaction has been conducted or recognizes the completed interaction, and communicates to a computing system associated with the application that the interaction has been conducted. The application receives from the computing system a post-interaction experience. A graphical user interface on the user computing device renders the post-interaction experience for display to the user and displays a received reward to the user if the user wins the game or otherwise earns the reward.

In certain other example aspects described herein, systems and computer program products to render graphical user interfaces to display post-interaction experiences to users are provided.

These and other aspects, objects, features and advantages of the example embodiments will become apparent to those having ordinary skill in the art upon consideration of the following detailed description of illustrated example embodiments.

### BRIEF DESCRIPTION OF THE DRAWINGS

FIG. 1 is a block diagram depicting a system to display a graphical user interface to display a post-transaction gamification experience to a user computing device, in accordance with certain examples.

FIG. 2 is a block flow diagram depicting a method to display a graphical user interface to display a post-transaction gamification experience to a user computing device, in accordance with certain examples.

FIG. 3 is a block flow diagram depicting a method to register a user with digital wallet network and configure a digital wallet application, in accordance with certain examples.

FIG. 4 is an illustration of an example graphical user interface displaying a post-transaction game, in accordance with certain examples.

FIG. 5 is an illustration of an example graphical user interface displaying a result of a post-transaction game, in accordance with certain examples.

FIG. 6 is a block diagram depicting a computing machine and a module, in accordance with certain examples.

### DETAILED DESCRIPTION OF THE EXAMPLE EMBODIMENTS

### Overview

In certain examples, a computing system provides graphical user interfaces for displaying a post-interaction gamification experience to users. The computing system provides a game or other reward display to a user to incentivize additional NFC interactions with third party systems. In examples the computing system is a digital wallet system, the interaction is a transaction, and the third party system is a merchant. In examples an application used in the interaction is a digital wallet application.

Contactless payments can be conducted by a payment instrument, such as a debit card or a credit card, with a point of sale (“POS”) terminal of a merchant. The payment instrument may be presented to the POS by a user computing device with the capability of communicating with a POS reader via contactless communication.

The user computing device can communicate with the terminal or with a contactless payment instrument via near field communication (“NFC”), BLUETOOTH, barcode, Wi-Fi, infrared, or any other suitable communication technology. The user computing device can host a payment application, such as a digital wallet application module, that can be used to communicate with the contactless payment instrument or a POS terminal.

The POS terminal can obtain the payment information from the contactless payment instrument. A payment can be initiated by a “tap,” swipe,” or other motion of the contactless payment instrument or via a feature selection from the user. The POS terminal can submit transaction details to a card network to receive payment from a card issuer associated with the payment instrument.

Providers of digital wallet applications, payment account providers, card issuers, merchants, and others may desire to drive a greater number of interactions, such as transactions, towards using a new technology. Because users have other options to initiate and conduct a transaction, these entities need a manner of encouraging and incentivizing further wireless transactions, such as NFC transactions. However, NFC transactions may be intimidating to new users, despite the fact that NFC transactions may be quicker, more efficient, and just as secure as conventional transactions. Thus, when users do not elect to use an incentivized transaction technology, all of the related computing devices are forced to perform additional processing and expend additional capacity.

In an example embodiment, a user employs a user computing device to register and configure a digital wallet account. The user downloads a digital wallet application on the user computing device, such as a mobile smartphone. The user associates one or more payment accounts with the digital wallet account. The payment accounts may be credit card accounts, debit accounts, bank accounts, stored value accounts, or any other suitable payment accounts.

In an example, the payment instrument is used in a transaction with a merchant system POS terminal. In an example, the user approaches a merchant system POS terminal with one or more items for purchase. The user swipes or taps the user computing device with the payment instrument on a POS terminal reader and initiates a communication between the payment instrument and the POS terminal. The POS terminal may employ a card reader or other hardware or software to communicate wirelessly with the payment instrument via NFC or other suitable technology. The digital wallet application transmits the payment account information to the reader on the POS terminal. The transaction is conducted with a payment processing system. Throughout the specification, the term transaction is used as a example interaction between the user computing device and the merchant system. In another example, any other suitable type of interaction that is not a transaction may be utilized. Such as a check in interaction, a verification interaction, an access interaction, or any other suitable interaction.

The digital wallet application communicates to the digital wallet system that the transaction was conducted using the preferred communication technology. The digital wallet system communicates a game, reward, or other post-transaction experience (collectively referred to herein as a “game”) to the digital wallet application on the user computing device.

The user interface 114 on the user computing device presents the game to the user as a graphical user interface, and the user plays the game. For example, the game may be a lottery type game where the user clicks a button to see if a prize was randomly selected, such as a gift card. In another example, the game may be a game of skill requiring the user to solve a puzzle, or perform some other skill related task. In another example, a reward is simply presented to the user, such as an offer or a coupon.

The display of the post-transaction game gives the user a sense of surprise and anticipation. The display incentivizes the user to conduct additional transactions using the preferred transaction technology because the user will want to revisit the surprise and anticipation.

While certain examples herein are depicted with an NFC transaction at a merchant location, the method may alternatively be performed in a different transaction environment. For example, the method may be used in an online transaction. Instead of the graphical user interface displaying the post-transaction experience after an NFC transaction the graphical user interface may display the post-transaction experience after an online transaction with a website of a merchant system. Any other suitable transaction type may utilize the method described herein.

By using and relying on the methods and systems described herein, the graphical user interface of the digital wallet system dynamically provides a post-transaction gamification experience to a user. As such, the systems and methods described herein may be employed to surprise and delight a user to incentivize that user to use the digital wallet system more frequently. The system is improved for the merchant system in that NFC transactions, which are faster and more efficient, happen more frequently. The offers are improved for user in that they enjoy the experience, but also obtain faster and more efficient transactions with the merchant. Hence, the methods and systems described herein permit the computing systems of the user, the digital wallet system, and the merchant system to all operate more efficiently.

### Example System Architectures

Turning now to the drawings, in which like numerals represent like (but not necessarily identical) elements throughout the figures, example embodiments are described in detail.

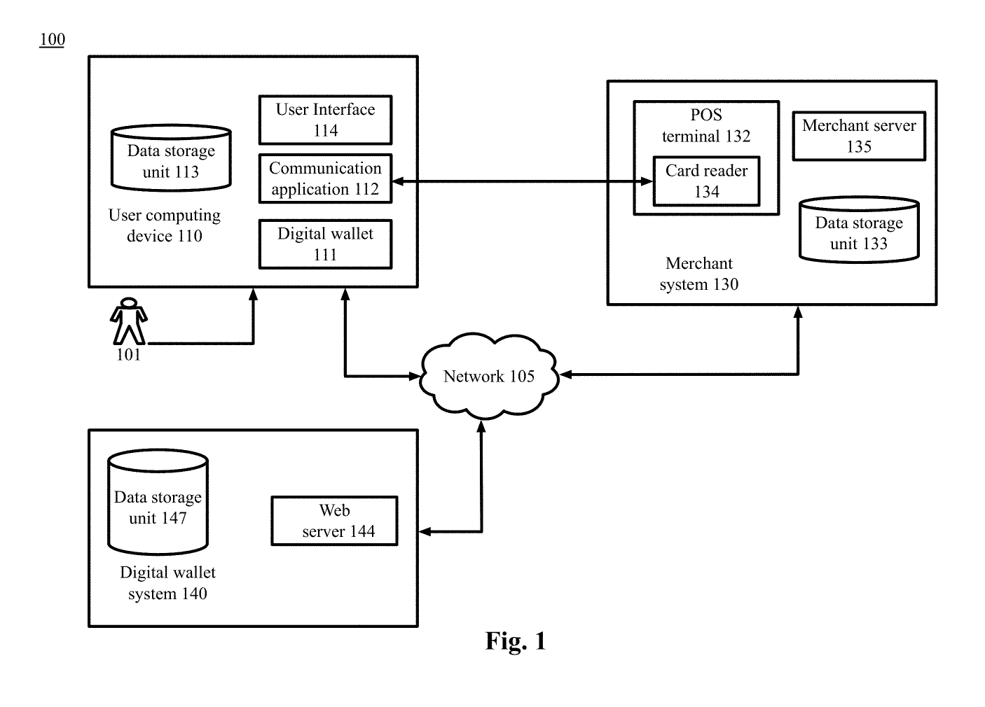

FIG. 1 is a block diagram depicting a system 100 to display a graphical user interface to display a post-transaction gamification experience to a user computing device 110, in accordance with certain examples. In some embodiments, a user 101 associated with a device must install an application and/or make a feature selection to obtain the benefits of the techniques described herein.

As depicted in FIG. 1, the system 100 includes network computing devices 110, 130, and 140 that are configured to communicate with one another via one or more networks 105 or via any suitable communication technology.

Each network 105 includes a wired or wireless telecommunication means by which network devices (including devices 110, 130, and 140) can exchange data. For example, each network 105 can include a local area network (“LAN”), a wide area network (“WAN”), an intranet, an Internet, a mobile telephone network, storage area network (SAN), personal area network (PAN), a metropolitan area network (MAN), a wireless local area network (WLAN), a virtual private network (VPN), a cellular or other mobile communication network, Bluetooth, NFC, or any combination thereof or any other appropriate architecture or system that facilitates the communication of signals, data. Throughout the discussion of example embodiments, it should be understood that the terms “data” and “information” are used interchangeably herein to refer to text, images, audio, video, or any other form of information that can exist in a computer-based environment. The communication technology utilized by the devices 110, 130, and 140 may be similar networks to network 105 or an alternative communication technology.

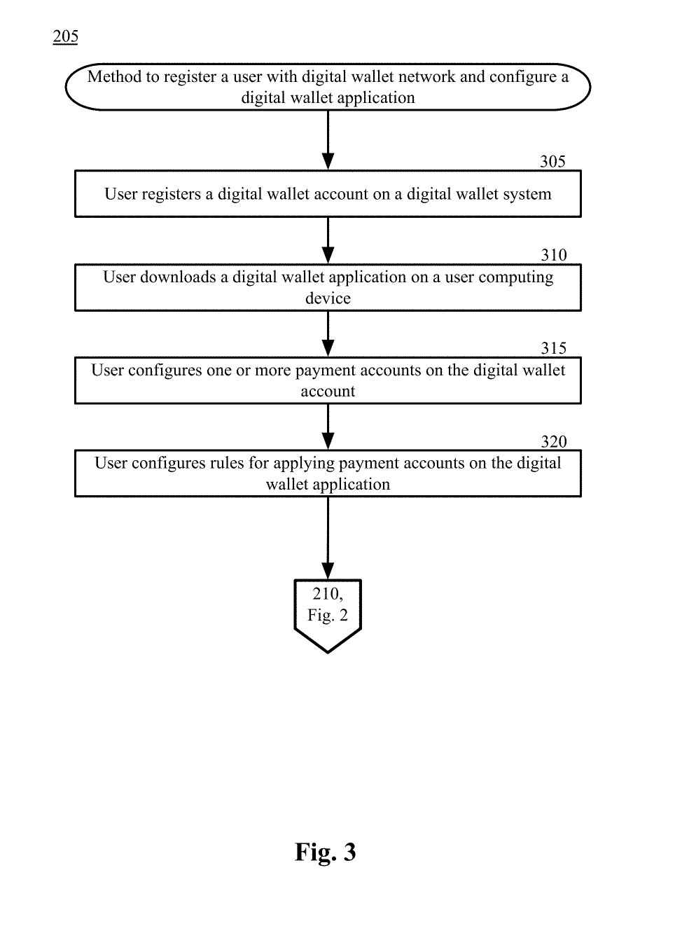

Each network computing device 110, 130, and 140 includes a computing device having a communication module capable of transmitting and receiving data over the network 105 or a similar network. For example, each network device 110, 130, and 140 can include a server, desktop computer, laptop computer, tablet computer, a television with one or more processors embedded therein and/or coupled thereto, smart phone, handheld or wearable computer, personal digital assistant (“PDA”), wearable devices such as smart watches or glasses, or any other wired or wireless, processor-driven device. In the example embodiment depicted in FIG. 3, the network devices 110, 130, and 140 are operated by end-users or consumers, merchant system operators, and digital wallet system operators, respectively.

The user 101 can use the communication application 112 on a user computing device 110, which may be, for example, a web browser application or a stand-alone application, to view, download, upload, or otherwise access documents or web pages via a distributed network 105. The communication application 112 can interact with web servers or other computing devices connected to the network 105, including the web server 144 of the digital wallet system 140.

In another example, the communication application 112 communicates with devices in the merchant system 130 via near field communication (“NFC”) or other wireless communication technology, such as Bluetooth, WiFi, infrared, or any other suitable technology. As used throughout the specification, the term “NFC” will be used to represent any wireless communication technology. The communication application 112 may use NFC to communicate payment information, receive transaction data, or perform any other suitable tasks.

The user computing device 110 includes a user interface 114 that is used to display a graphical user interface and other user interfaces. The user interface 114 may be used to display information to the user 101 to allow the user 101 to interact with the digital wallet system 140, the digital wallet application 111, and others. The user interface 114 receives user input for transactions and displays results to the user 101. In certain examples, the user interface 114 may be managed by the digital wallet system 140. The user interface 114 may be accessed by the user computing device 110. The grapical user interface 114 may display the webpage 144 of the digital wallet system 140. In certain examples, the user interface 114 may be managed by a merchant system 130 or others. In certain examples, the user interface 114 may be managed by the user computing device 110 and be prepared and displayed to the user 101 based on the operations of the user computing device 110.

The user interface 114 may be used to display a graphical user interface for a post-transaction experience instructions from the digital wallet system 140 to the user 101 as described herein.

The user computing device 110 may include a digital wallet application 111. The digital wallet application 111 may encompass any application, hardware, software, or process the user computing device 110 may employ to assist the user 101 in completing a purchase. The digital wallet application 111 can interact with the communication application 112 or can be embodied as a companion application of the communication application 112. As a companion application, the digital wallet application 111 executes within the communication application 112. That is, the digital wallet application 111 may be an application program embedded in the communication application 112. In certain embodiments a digital wallet of the user 101 may reside in a cloud computing environment, on a merchant server, or in any other environment.

The digital wallet application 111 communicates transaction status to the digital wallet system 140, such as when a transaction is completed. The digital wallet application 111 receives post-transaction experience instructions from the digital wallet system 140 for display to the user 101 on the graphical user interface 114.

The user computing device 110 also includes a data storage unit 113 accessible by the digital wallet application 111, the communication application 112 or other applications. The example data storage unit 113 can include one or more tangible computer-readable storage devices. The data storage unit 113 can be stored on the user computing device 110 or can be logically coupled to the user computing device 110. For example, the data storage unit 113 can include on-board flash memory and/or one or more removable memory accounts or removable flash memory. In certain embodiments, the data storage unit 113 may reside in a cloud based computing system.

The digital wallet system 140 may include a data storage unit 147 accessible by the web server 144. The example data storage unit 147 can include one or more tangible computer-readable storage devices, or the data storage unit may be a separate system, such as, a different physical or virtual machine, or a cloud-based storage service.

The digital wallet system 140 may be any system that manages, configures, enables, or otherwise services a digital wallet for a user 101. The digital wallet system 140 may provide a mechanism for a user 101 to conduct transactions with a merchant system 130. The digital wallet system 140 may provide software or other applications to a user computing device 110 to conduct digital wallet transactions on the user computing device 110.

The digital wallet system 140 may provide the user 101 with a customer identification (“ID”) that identifies the account of the user 101 on the digital wallet system 140. The digital wallet system 140 may utilize the customer ID to access loyalty information of the user 101, stored or associated offers, payment instruments, or other suitable data.

The digital wallet system 140 may transmit post-transaction experience instructions to the digital wallet application 111 for display to the user 101 on the user interface 114.

An example merchant system 130 comprises a server 135, a data storage unit 133, a merchant POS terminal 132, and a card reader 134.

In an example embodiment, the server 135 communicates with the digital wallet system 140 to transmit and receive customer IDs, payment information, loyalty information, offers, and other useful data. The merchant server 135 receives data from the POS terminal 132 and assists in conducting transactions with payment processing systems, card issuers, and other suitable systems.

In an example embodiment, the data storage unit 133 can include any local or remote data storage structure accessible to the merchant system 130 suitable for storing information. In an example embodiment, the data storage unit 133 stores encrypted information.

In an example embodiment, the merchant POS terminal 132, such as a cash register, is capable of processing a purchase transaction initiated by a user 101. In an example embodiment, the merchant system 130 operates a commercial store and the user 101 indicates a desire to make a purchase by presenting a form of payment at the merchant POS terminal 132. In an example embodiment, the merchant POS terminal 132 is capable of communicating with the user computing device 110 using an NFC, Bluetooth, and/or Wi-Fi communication method. In an example, the POS terminal 132 utilizes a card reader 134 to communicate with a payment instrument 115 of the user 101. The card reader may receive data from a magnetic stripe, NFC, or any other suitable payment instrument technology.

It will be appreciated that the network connections shown are examples and other means of establishing a communications link between the computers and devices can be used. Moreover, those having ordinary skill in the art having the benefit of the present disclosure will appreciate that the merchant system 130, digital wallet system 140, and the user computing device 110 illustrated in FIG. 1 can have any of several other suitable computer system configurations. For example, a user computing device 110 embodied as a mobile phone or handheld computer may not include all the components described above.

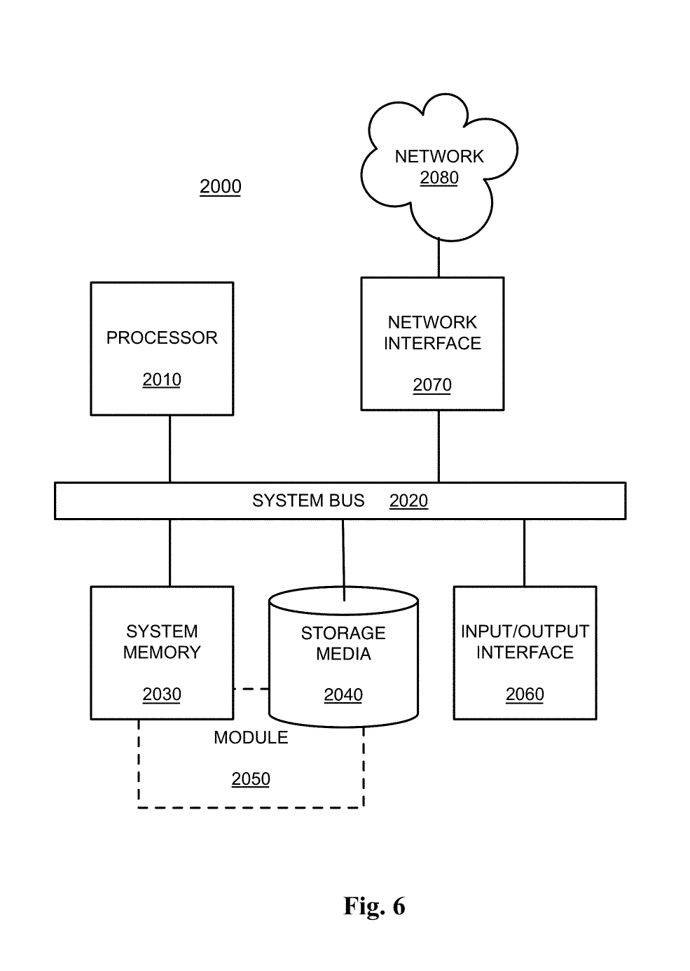

In example embodiments, the network computing devices and any other computing machines associated with the technology presented herein may be any type of computing machine such as, but not limited to, those discussed in more detail with respect to FIG. 6. Furthermore, any modules associated with any of these computing machines, such as modules described herein or any other modules (scripts, web content, software, firmware, or hardware) associated with the technology presented herein may by any of the modules discussed in more detail with respect to FIG. 6. The computing machines discussed herein may communicate with one another as well as other computer machines or communication systems over one or more networks, such as network 105. The network 105 may include any type of data or communications network, including any of the network technology discussed with respect to FIG. 6.

### Example Processes

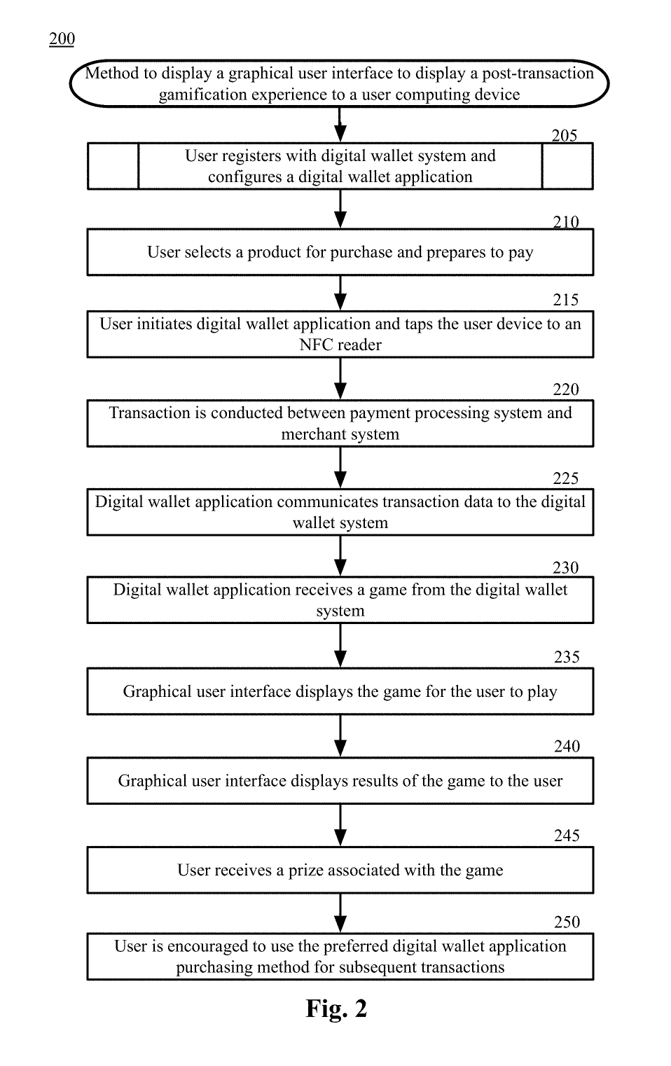

The example methods illustrated in FIG. 2-3 are described hereinafter with respect to the components of the example operating environment 100. The example methods of FIG. 2-3 may also be performed with other systems and in other environments.

FIG. 2 is a block flow diagram depicting a method 200 to display a graphical user interface 114 to display a post-transaction gamification experience to a user computing device 110, in accordance with certain example embodiments.

With reference to FIGS. 1-3, in block 205, a user 101 registers with digital wallet system 140 and configures a digital wallet application 114. The features of block 205 are described in greater detail with respect to method 205 of FIG. 3.

FIG. 3 is a block flow diagram depicting a method 205 to register a user 101 with digital wallet system 140 and configure a digital wallet application 111, in accordance with certain examples.

In block 305, a user 101 registers a digital wallet account on a digital wallet system 140. The user 101 may access a webpage of the digital wallet system 140 via the user interface 114 of the user computing device 110 to register an account, select usernames and passwords, and perform other registration tasks. The user 101 may register the account via digital wallet application 114 on the user computing device 110 or via any other suitable method, such as verbally over a telephone.

In block 310, the user 101 downloads a digital wallet application 111 on a user computing device 110. Blocks 505 and 510 may be performed in any suitable order. The digital wallet system 140 provides software to the user computing device 110, via network 105 to install the digital wallet application 111 on the user computing device 110. The user 101 or the digital wallet system 140 may configure the digital wallet application 111 with digital wallet data from the digital wallet system 140. The digital wallet application 111 may be downloaded or accessed from a third party server or any other suitable location. The digital wallet application 111 may alternatively be pre-installed on the user computing device 110 or otherwise come standard with the operating system on the user computing device 110.

In block 315, the user 101 configures one or more payment accounts on the digital wallet account of the digital wallet system 140. In an example, the digital wallet account on the digital wallet system 140 and the digital wallet application 111 may be configured with one or more payment accounts of the user 101. The payment accounts may be credit card accounts, debit accounts, bank accounts, stored value accounts, or any other suitable payment accounts. The digital wallet account may be configured with loyalty information of the user 101 for one or more merchant systems 130. The digital wallet account may be configured with offers associated with the user 101 from merchant systems 130, manufacturers, or other systems.

In block 320, the user 101 configures rules for applying payment accounts on the digital wallet application 140. For example, the user 101 may configure the digital wallet application 140 to default to a particular card unless otherwise instructed. The user 101 may configure the digital wallet application 140 to select a particular card at a particular merchant system 130. The user 101 may configure the digital wallet application 140 to select a particular card for a range of transaction amounts. Any other suitable rule may be configured by the user 101 to streamline the selection of a payment instrument when a transaction is initiated.

Returning to FIG. 2, in block 210, a user 101 selects a product for purchase and prepares to pay. For example, if the user 101 is at a physical location of a merchant system 130, the user 101 may select a product for purchase and approach a point of sale (“POS”) terminal 132 to conduct a transaction.

In block 215, a user 101 initiates a digital wallet application 111 and swipes or taps the user computing device 110 on a POS terminal reader 134. In an example, the user 101 approaches a merchant system POS terminal 132 with one or more items for purchase. The user 101 initiates the digital wallet application 111 and prepares the digital wallet application 111 for conducting a transaction. For example, the user 101 selects an icon or other object to initiate the digital wallet application 111. The user 101 may make a selection on the digital wallet application 111 to specify which payment instrument should be used in a subsequent transaction or make any other suitable selections.

The user 101 swipes or taps the user computing device 110 and initiates a communication between the user computing device 110 and the POS terminal 132. The tap may represent any action that is required to initiate a communication with the POS terminal 132. For example, the tap may require that the user 101 place the user computing device 110 flat on a surface of a card reader 134. In another example, the tap may require that the user 101 hover the user computing device 110 near an antenna of a card reader 134. Any other type of tap, swipe, or other initiating actions, may be employed. The POS terminal 132 may employ a card reader 134 or other hardware or software to communicate wirelessly with the user computing device 110 via NFC or other suitable technology.

In block 220, the transaction is conducted between a payment processing system and the merchant system 130. In an example, the card reader 134 or other communication element of a POS terminal 132 requests payment account information and other suitable data from the digital wallet application 111. The digital wallet application 111 assembles the necessary data for responding. The data may include the payment account number of a payment instrument, the expiration date of the payment instrument, and other suitable data.

The digital wallet application 111 transmits the payment account information to the reader 134 or other element of the POS terminal 132. The card reader 134 provides the payment account information to POS terminal 132. The card reader 134 transmits the collected data to the POS terminal 132 via any available communication technology. The POS terminal 132 transmits an authorization request a suitable payment processing system (not pictured). The POS terminal 132 identifies the transaction total and provides an authorization request to a credit card network, a payment processing system, a banking institution, or any suitable system that will provide an authorization for the transaction and process the transaction. The authorization, or a notification that the authorization has been received, is provided to the POS terminal 132 and the transaction is completed. The POS terminal 132 displays the authorization to the user 101 and/or a salesperson of the merchant system 130. The user 101 receives the purchased product or service and a paper or digital receipt for the transaction.

In block 225, the digital wallet application 111 communicates transaction data to the digital wallet system 140. After the transaction is completed, the digital wallet application 111 recognizes that the POS terminal 132 has communicated information indicating that the transaction is complete, such as a receipt. The communication from the POS terminal 132 may be via NFC or any other suitable technology. The digital wallet application 111 communicates the completion of the transaction to the digital wallet system 140 via an Internet connection via the network 105, or via any other suitable technology. In another example, the digital wallet system 140 recognizes the transaction from the authorization process and does not require notification by the digital wallet application 111.

In block 230, the digital wallet application 111 receives a game from the digital wallet system 140. When the digital wallet system 140 receives notification that the transaction has been completed, the digital wallet system 140 determines if the transaction was conducted via a transaction method, or if another preferred action was performed, that is to be rewarded, or if another preferred action was performed. In an example, the game is to be provided in the post-transaction experience for transactions conducted via NFC. In another example, the post-transaction experience is provided for transactions conducted online using the digital wallet application 111. The digital wallet system 140 is able to determine the transaction method from details provided by the digital wallet application 111.

If the transaction was conducted via a preferred transaction method, the digital wallet system 140 determines the post-transaction experience to be provided to the digital wallet application 111. The post-transaction experience may be a game, a reward, or any other post-transaction experience (collectively referred to herein as a “game”). For example, the game to be provided to the digital wallet application 111 may be based on a rewards program, an advertising campaign, a transaction amount, the status of the user account, the type of merchant system 130, or any other suitable characteristic of the transaction. The digital wallet system 140 determines the appropriate game for the user 101, and communicates the game to the digital wallet application 111. The communication may be sent via an Internet connection over the network 105 or via any other suitable technology.

In an alternate example, the digital wallet application 111 accesses or provides the post-transaction experience. For example, the digital wallet system 140 may communicate a series of games to the digital wallet application 111 for storage. The digital wallet application 111 then accesses one of the games after approved transactions. In another example, the digital wallet application 111 is provided instructions to communicate with a third party server to access the post-transaction experience. Any suitable manner of accessing a post-transaction experience, such as a game, may be employed.

In block 235, the user interface 114 displays the game for the user 101 to play via a graphical user interface. For example, the game may be a lottery type game where the user 101 clicks a button to see if a prize was randomly selected, such as a gift card. If so, the lottery may be managed by the digital wallet system 140 and presented to the user computing device 110 for display by the graphical user interface displayed on the user interface 114. The functions of the game, such as the presentation of action of the user 101 required to initiate the game may be provided to the user interface 114 by the digital wallet system 140. Alternatively, the graphical user interface creates the display and gameplay functions to present to the user 101 on the user interface 114. In this case, the digital wallet system 140 may inform the user interface 114 that the user 101 has won and the prize he has won, and the graphical user interface selects the format to present the win to the user 101 on the user interface 114.

In another example, the graphical user interface presents a lottery type game, or a game of chance, to the user 101 requiring the user 101 to make a guess to win the prize. For example, the user 101 may be required to virtually “scratch off” one of three objects on the graphical user interface to determine if the user 101 has won a reward or prize. In another example, the user 101 might spin a virtual wheel to determine what prize has been won.

In another example, the game presented to the user by the graphical user interface may be a game of skill requiring the user 101 to solve a puzzle, or perform some other skill related task. For example, the user 101 may be required to complete a maze, drive a virtual car in a race, or perform any other gameplay requiring skill to win the prize. In another example a reward is simply presented to the user 101, such as an offer or a coupon.

The digital wallet system 140 may dictate the odds that the user 101 will win and the amount of rewards that might be won. For example, the digital wallet system 140 may dictate that 1000 users will win $50 gift certificates over the duration of the campaign. While the digital wallet system 140 may apply a randomness to which of the users 101 will win a reward, the total amount of rewards is configurable. For example, when a user 101 plays a game of chance, the digital wallet system 140 may not dictate if the user 101 is going to win, but the digital wallet system 140 may dictate the odds that the user 101 will win, such as one out of ten attempts.

In certain examples, the digital wallet system 140 determines if the user 101 has won before the post-transaction game is communicated to the user computing device 110. That is, the entry is determined randomly to have won or not won before communication to the digital wallet application 111. In another example, the post-transaction game is communicated to the user computing device 110 with configured odds that the user 101 will win. For example, three buttons may be provided to the user 101 with only one button being a winner. The user 101 will have a one in three chance of selecting the correct button and winning the reward.

An example of the display of the game to the user 101 is shown in FIGS. 1 and 2. FIG. 1 is an illustration of an example graphical user interface displaying a post-transaction game on a user interface 114 of a user computing device 110, in accordance with certain examples.

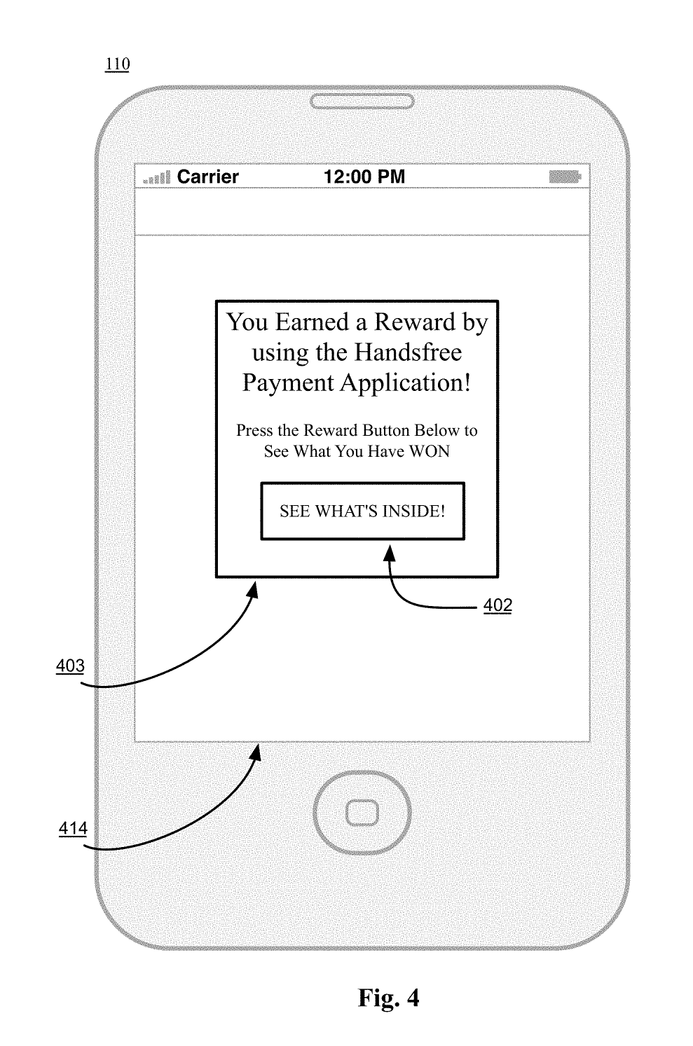

An example user computing device 110 is provided in FIG. 4. The user computing device 110 is shown as a mobile smartphone 110 with a display screen presenting a graphical user interface. In the example, the graphical user interface presents post-transaction game experience to a user 101 including a game display 103. The game display 403 informs a user 101 that they have won an award and the user 101 should actuate the virtual button 402 to receive the reward. In certain examples, the game display 403 and the virtual button 402 may be any type of game that might interest the user 101. For example, the virtual button 402 may be presented as a bullseye, red button, a firework cracker, or any suitable display.

Returning to FIG. 2, in block 240, the graphical user interface displays results of the game to the user 101. When the user 101 plays the game or performs any other required action, the graphical user interface displays the rewards or other item that the user 101 has won. In certain embodiments, a game is not actually played and the graphical user interface displays the results to the user 101 without a post-transaction game being displayed. That is, after the digital wallet application 111 receives the game (or reward information) from the digital wallet system 140 as described in block 230, the rewards display is presented to the user 101 without the user 101 being required to perform any tasks.

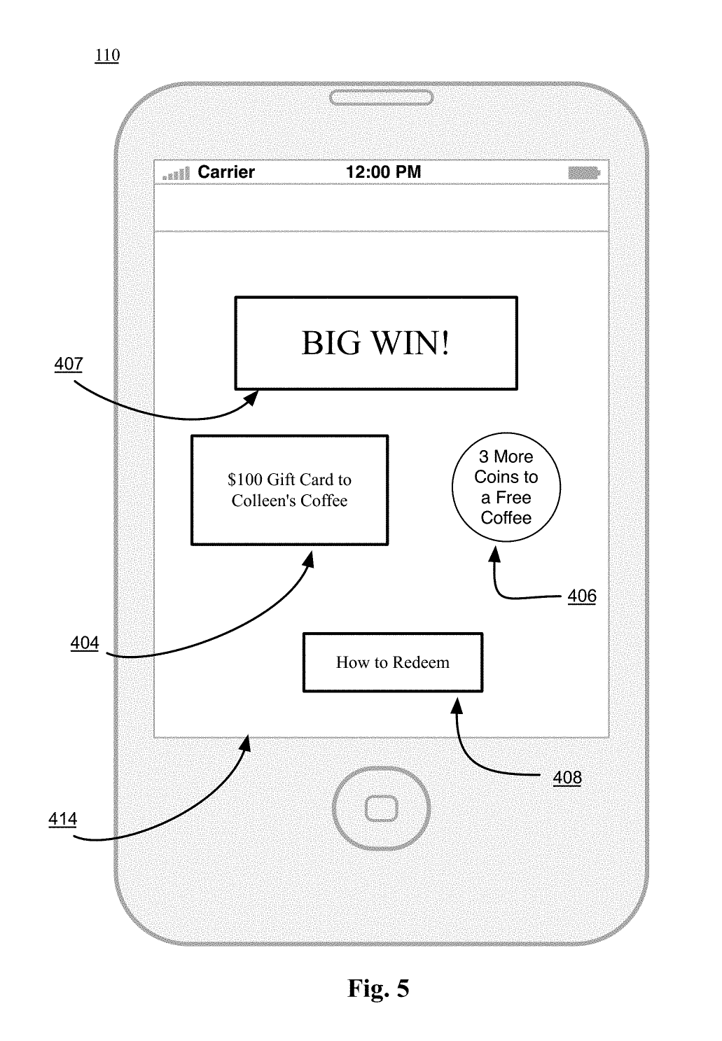

An example rewards presentation on the graphical user interface displayed on the user computing device 110 is illustrated in FIG. 5. FIG. 5 is an illustration of an example graphical user interface displaying a result of a post-transaction game, in accordance with certain examples.

After the user 101 actuates the virtual button 402, for example, the graphical user interface displays to the user 101 what, if anything, has been won. For example, the display 407 informs the user 101 that a reward has been won. The gift certificate 404 informs the user 101 of the specific gift that has been won. The gift certificate 404 may alternatively be an offer, a loyalty reward, or any suitable reward. The loyalty coin 406 illustrates a type of reward that the user 101 may have won or merely earned by virtue of playing the game. In this example, the user 101 collects coins 406 towards earning a free coffee. Any suitable loyalty point representation may be displayed. The graphical user interface displays a redeem button 408 to indicate to a user 101 the method to redeem the reward. The redeem button 408 may direct a user 101 to a webpage of instructions for redemption, to a merchant webpage with details on redemption, to a merchant shopping webpage with a product to be redeemed, or to any suitable location to provide instructions to the user 101.

Returning to FIG. 2, in block 245, the user 101 receives a prize associated with the game. After the user 101 receives the post-transaction experience, the user 101 may select an option to redeem the prize. For example, the user 101 may receive a gift certificate emailed to the email account of the user 101 or stored in the digital wallet account of the user 101. The user 101 may be directed to a webpage of a merchant system 130 to receive a free gift. Any suitable method of providing a gift to the user 101 may be used.

In block 250, the user 101 is encouraged to use the preferred digital wallet application 111 purchasing method for subsequent transactions. When the user 101 receives the post-transaction experience, whether it is a fun game or just a reward, the user 101 is incentivized to use the digital wallet system 140 more frequently, which causes all of the systems involved to operate more efficiently.

Other examples include a computer program product, comprising a non-transitory computer-readable storage device having computer-executable program instructions embodied thereon that when executed by a computer cause the computer to render graphical user interfaces to display post-transaction experiences to users. The computer-executable program instructions comprising computer-executable program instructions to display a digital wallet application to a user to initiate a wireless interaction; to receive a notification of a tap of the one or more computing devices to conduct a pending interaction at a merchant system; to receive a notification from the merchant system that the interaction has been authorized; to receive from the digital wallet system a post-interaction experience; to render, on the graphical user interface, the post-interaction experience for display to the user; and to display, on the graphical user interface, a received reward to the user.

The computer program product further comprises computer-executable program instructions to communicate to provide payment account information to the merchant system. In an example, the post-transaction experience may be a game requiring a particular skill of the user. In an example, the post-transaction experience is a game of chance. In an example, the computer program product further comprises computer-executable program instructions to receive from the digital wallet system, instructions providing the results of the game of chance to display to the user. In an example, the interaction is a transaction.

In another example, a system renders graphical user interfaces to display post-transaction experiences to users, comprising a user computing device comprising a user computing device processor communicatively coupled to a user computing device storage resource. The user computing device processor executes application code instructions that are stored in the user computing device storage resource to cause the user computing device processor to display a digital wallet application to a user to initiate a wireless transaction; receive a notification from a merchant system that the transaction has been conducted; communicate to a digital wallet system associated with the digital wallet application that the transaction has been conducted; initiate a wireless communication with the digital wallet system; receive from the digital wallet system a post-transaction experience; render, on the graphical user interface, the post-transaction experience for display to the user; and display, on the graphical user interface, a received reward to the user.

In an example, the post-transaction experience is a game of chance. In an example, the post-transaction experience is a game requiring a particular skill of the user. In an example, the system further comprises receiving a notification of a tap of a user computing device to conduct a pending transaction at a merchant system. In an example, the system further comprises communicating payment account information to the merchant system.

### Example Systems

FIG. 6 depicts a computing machine 2000 and a module 2050 in accordance with certain example embodiments. The computing machine 2000 may correspond to any of the various computers, servers, mobile devices, embedded systems, or computing systems presented herein. The module 2050 may comprise one or more hardware or software elements configured to facilitate the computing machine 2000 in performing the various methods and processing functions presented herein. The computing machine 2000 may include various internal or attached components such as a processor 2010, system bus 2020, system memory 2030, storage media 2040, input/output interface 2060, and a network interface 2070 for communicating with a network 2080.

The computing machine 2000 may be implemented as a conventional computer system, an embedded controller, a laptop, a server, a mobile device, a smartphone, a wearable computer, a set-top box, a kiosk, a vehicular information system, one more processors associated with a television, a customized machine, any other hardware platform, or any combination or multiplicity thereof. The computing machine 2000 may be a distributed system configured to function using multiple computing machines interconnected via a data network or bus system.

The processor 2010 may be configured to execute code or instructions to perform the operations and functionality described herein, manage request flow and address mappings, and to perform calculations and generate commands. The processor 2010 may be configured to monitor and control the operation of the components in the computing machine 2000. The processor 2010 may be a general purpose processor, a processor core, a multiprocessor, a reconfigurable processor, a microcontroller, a digital signal processor (“DSP”), an application specific integrated circuit (“ASIC”), a graphics processing unit (“GPU”), a field programmable gate array (“FPGA”), a programmable logic device (“PLD”), a controller, a state machine, gated logic, discrete hardware components, any other processing unit, or any combination or multiplicity thereof. The processor 2010 may be a single processing unit, multiple processing units, a single processing core, multiple processing cores, special purpose processing cores, co-processors, or any combination thereof. According to certain embodiments, the processor 2010 along with other components of the computing machine 2000 may be a virtualized computing machine executing within one or more other computing machines.

The system memory 2030 may include non-volatile memories such as read-only memory (“ROM”), programmable read-only memory (“PROM”), erasable programmable read-only memory (“EPROM”), flash memory, or any other device capable of storing program instructions or data with or without applied power. The system memory 2030 may also include volatile memories such as random access memory (“RAM”), static random access memory (“SRAM”), dynamic random access memory (“DRAM”), and synchronous dynamic random access memory (“SDRAM”). Other types of RAM also may be used to implement the system memory 2030. The system memory 2030 may be implemented using a single memory module or multiple memory modules. While the system memory 2030 is depicted as being part of the computing machine 2000, one skilled in the art will recognize that the system memory 2030 may be separate from the computing machine 2000 without departing from the scope of the subject technology. It should also be appreciated that the system memory 2030 may include, or operate in conjunction with, a non-volatile storage device such as the storage media 2040.

The storage media 2040 may include a hard disk, a floppy disk, a compact disc read-only memory (“CD-ROM”), a digital versatile disc (“DVD”), a Blu-ray disc, a magnetic tape, a flash memory, other non-volatile memory device, a solid sate drive (“SSD”), any magnetic storage device, any optical storage device, any electrical storage device, any semiconductor storage device, any physical-based storage device, any other data storage device, or any combination or multiplicity thereof. The storage media 2040 may store one or more operating systems, application programs and program modules such as module 2050, data, or any other information. The storage media 2040 may be part of, or connected to, the computing machine 2000. The storage media 2040 may also be part of one or more other computing machines that are in communication with the computing machine 2000 such as servers, database servers, cloud storage, network attached storage, and so forth.

The module 2050 may comprise one or more hardware or software elements configured to facilitate the computing machine 2000 with performing the various methods and processing functions presented herein. The module 2050 may include one or more sequences of instructions stored as software or firmware in association with the system memory 2030, the storage media 2040, or both. The storage media 2040 may therefore represent examples of machine or computer readable media on which instructions or code may be stored for execution by the processor 2010. Machine or computer readable media may generally refer to any medium or media used to provide instructions to the processor 2010. Such machine or computer readable media associated with the module 2050 may comprise a computer software product. It should be appreciated that a computer software product comprising the module 2050 may also be associated with one or more processes or methods for delivering the module 2050 to the computing machine 2000 via the network 2080, any signal-bearing medium, or any other communication or delivery technology. The module 2050 may also comprise hardware circuits or information for configuring hardware circuits such as microcode or configuration information for an FPGA or other PLD.

The input/output (“I/O”) interface 2060 may be configured to couple to one or more external devices, to receive data from the one or more external devices, and to send data to the one or more external devices. Such external devices along with the various internal devices may also be known as peripheral devices. The I/O interface 2060 may include both electrical and physical connections for operably coupling the various peripheral devices to the computing machine 2000 or the processor 2010. The I/O interface 2060 may be configured to communicate data, addresses, and control signals between the peripheral devices, the computing machine 2000, or the processor 2010. The I/O interface 2060 may be configured to implement any standard interface, such as small computer system interface (“SCSI”), serial-attached SCSI (“SAS”), fiber channel, peripheral component interconnect (“PCP”), PCI express (PCIe), serial bus, parallel bus, advanced technology attached (“ATA”), serial ATA (“SATA”), universal serial bus (“USB”), Thunderbolt, FireWire, various video buses, and the like. The I/O interface 2060 may be configured to implement only one interface or bus technology. Alternatively, the I/O interface 2060 may be configured to implement multiple interfaces or bus technologies. The I/O interface 2060 may be configured as part of, all of, or to operate in conjunction with, the system bus 2020. The I/O interface 2060 may include one or more buffers for buffering transmissions between one or more external devices, internal devices, the computing machine 2000, or the processor 2010.

The I/O interface 2060 may couple the computing machine 2000 to various input devices including mice, touch-screens, scanners, electronic digitizers, sensors, receivers, touchpads, trackballs, cameras, microphones, keyboards, any other pointing devices, or any combinations thereof. The I/O interface 2060 may couple the computing machine 2000 to various output devices including video displays, speakers, printers, projectors, tactile feedback devices, automation control, robotic components, actuators, motors, fans, solenoids, valves, pumps, transmitters, signal emitters, lights, and so forth.

The computing machine 2000 may operate in a networked environment using logical connections through the network interface 2070 to one or more other systems or computing machines across the network 2080. The network 2080 may include wide area networks (WAN), local area networks (LAN), intranets, the Internet, wireless access networks, wired networks, mobile networks, telephone networks, optical networks, or combinations thereof. The network 2080 may be packet switched, circuit switched, of any topology, and may use any communication protocol. Communication links within the network 2080 may involve various digital or an analog communication media such as fiber optic cables, free-space optics, waveguides, electrical conductors, wireless links, antennas, radio-frequency communications, and so forth.

The processor 2010 may be connected to the other elements of the computing machine 2000 or the various peripherals discussed herein through the system bus 2020. It should be appreciated that the system bus 2020 may be within the processor 2010, outside the processor 2010, or both. According to some embodiments, any of the processor 2010, the other elements of the computing machine 2000, or the various peripherals discussed herein may be integrated into a single device such as a system on chip (“SOC”), system on package (“SOP”), or ASIC device.

In situations in which the systems discussed here collect personal information about users, or may make use of personal information, the users may be provided with a opportunity to control whether programs or features collect user information (e.g., information about a user's social network, social actions or activities, profession, a user's preferences, or a user's current location), or to control whether and/or how to receive content from the content server that may be more relevant to the user. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Embodiments may comprise a computer program that embodies the functions described and illustrated herein, wherein the computer program is implemented in a computer system that comprises instructions stored in a machine-readable medium and a processor that executes the instructions. However, it should be apparent that there could be many different ways of implementing embodiments in computer programming, and the embodiments should not be construed as limited to any one set of computer program instructions. Further, a skilled programmer would be able to write such a computer program to implement an embodiment of the disclosed embodiments based on the appended flow charts and associated description in the application text. Therefore, disclosure of a particular set of program code instructions is not considered necessary for an adequate understanding of how to make and use embodiments. Further, those skilled in the art will appreciate that one or more aspects of embodiments described herein may be performed by hardware, software, or a combination thereof, as may be embodied in one or more computing systems. Moreover, any reference to an act being performed by a computer should not be construed as being performed by a single computer as more than one computer may perform the act.

The example embodiments described herein can be used with computer hardware and software that perform the methods and processing functions described previously. The systems, methods, and procedures described herein can be embodied in a programmable computer, computer-executable software, or digital circuitry. The software can be stored on computer-readable media. For example, computer-readable media can include a floppy disk, RAM, ROM, hard disk, removable media, flash memory, memory stick, optical media, magneto-optical media, CD-ROM, etc. Digital circuitry can include integrated circuits, gate arrays, building block logic, field programmable gate arrays (FPGA), etc.

The example systems, methods, and acts described in the embodiments presented previously are illustrative, and, in alternative embodiments, certain acts can be performed in a different order, in parallel with one another, omitted entirely, and/or combined between different example embodiments, and/or certain additional acts can be performed, without departing from the scope and spirit of various embodiments. Accordingly, such alternative embodiments are included in the inventions described herein.

Although specific embodiments have been described above in detail, the description is merely for purposes of illustration. It should be appreciated, therefore, that many aspects described above are not intended as required or essential elements unless explicitly stated otherwise. Modifications of, and equivalent components or acts corresponding to, the disclosed aspects of the example embodiments, in addition to those described above, can be made by a person of ordinary skill in the art, having the benefit of the present disclosure, without departing from the spirit and scope of embodiments defined in the following claims, the scope of which is to be accorded the broadest interpretation so as to encompass such modifications and equivalent structures.

What is claimed is:

1. A computer-implemented method to render graphical user interfaces to display post-interaction animations to users, comprising:
displaying, using a user interface of one or more computing devices, an application to a user to initiate a wireless interaction;
receiving, using the one or more computing devices and from a third party system, a notification of a tap of the one or more computing devices to conduct a pending interaction at the merchant system;
providing, using the one or more computing devices, account information to the third party system;
receiving, using the one or more computing devices, a notification from the third party system that the interaction has been authorized;
communicating, using the one or more computing devices and to a computing system associated with the application, that the interaction has been authorized;
receiving, using the one or more computing devices and from the computing system, a post-interaction animation;
rendering, using the user interface on the one or more computing devices, the post-interaction animation graphical user interface for display to the user; and
displaying, using the graphical user interface on the one or more computing devices, a received reward to the user.

2. The computer-implemented method of claim 1, wherein the post-interaction animation is a game requiring a particular skill of the user.

3. The computer-implemented method of claim 1, wherein the post-interaction animation is a game of chance.

4. The computer-implemented method of claim 3, further comprising receiving, using the one or more computing devices and from the computing system, instructions providing the results of the game of chance to display to the user.

5. The computer-implemented method of claim 1, further comprising receiving, using the one or more computing devices and from the computing system, rules dictating the odds that the user will win the reward.

6. The computer-implemented method of claim 1, wherein the reward is a gift certificate.

7. The computer-implemented method of claim 1, wherein the reward is loyalty points.

8. The computer-implemented method of claim 1, wherein the post-interaction animation is received only when a predetermined interaction technology is used for the interaction.

9. The computer-implemented method of claim 1, wherein a series of games as post-interaction animation are communicated from the computing system to the application for storage and the application accesses one of the games as the post-interaction animation after the interaction has been authorized.

10. The computer-implemented method of claim 1, further comprising requiring, using the one or more computing devices, the user to perform a task to receive the reward.
